(19) United States
(12) Patent Application Publication
(10) Pub. No.: US 2009/0021580 A1
(43) Pub. Date: Jan. 22, 2009

(54) CAMERA CALIBRATION DEVICE AND CAMERA CALIBRATION METHOD

(75) Inventors: Tomohide Ishigami, Tokyo (JP); Kensuke Maruya, Kanagawa (JP); Susumu Okada, Kanagawa (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Kadoma-shi, Osaka (JP)

(21) Appl. No.: 11/573,461

(22) PCT Filed: Aug. 18, 2005
(86) PCT No.: PCT/JP05/15053

§ 371 Date: Feb. 9, 2007

(30) Foreign Application Priority Data
Aug. 27, 2004 (JP) 2004-247931

(51) Int. Cl. H04N 7/18

(52) U.S. Cl. 348/142; 348/E17.002

(57) ABSTRACT

One objective of the invention is to simplify a calibration correction operation.

According to the present invention, a camera calibration apparatus, which obtains camera parameters based on a correlation between world coordinates, in real space, and image coordinates, in an image recorded by a camera, includes: a calibration unit A113, for obtaining camera parameters by employing a set of coordinates for an index point, for which a coordinate value on the world coordinates is previously known, and a corresponding point on the image coordinates, which is correlated with the index point; a calibration correction unit A114, for detecting a correlation error for a correlation between the world coordinate value of the index point and an image coordinate value of the corresponding point; and a display controller A112, for displaying the detected correlation error on an image display device, by correlating the index point with the corresponding point.

### TECHNICAL FIELD

The present invention relates to a camera calibration apparatus that obtains a camera parameter based on a correlation between world coordinates, located in real space, and image coordinates, located in an image obtained by a camera, and a camera calibration method.

### BACKGROUND ART

Recently, there has arrived, in the security field, an apparatus that automatically detects, through image processing, a suspicious-looking portion in a monitoring image obtained by a camera. Further, when a camera parameter used to correlate image coordinates located in the monitoring image with world coordinates located in real space is obtained, the location in real space can be designated based on a point in the image.

This operation for obtaining the camera parameter is called camera calibration, and the camera parameter can be acquired by employing a correlation between the world coordinates, located in real space, and the image coordinates, located in an image obtained by the camera. For example, the following is a basic method. An index point at which previously known world coordinates are located for calibration is photographed using a camera, and a correlated point on the photographed image is obtained. Then, a camera parameter is obtained based on equal to or greater than six index points at which the world coordinates and the image coordinates are correlated with each other but are not located on the same plane. A typical method is described in non-patent document 1.

FIG. 10 is a diagram for explaining a correlation between image coordinates and world coordinates. A method for obtaining a camera parameter will be briefly explained while referring to FIG. 10. By employing a scale s, a relationship represented by (Ex. 1) is established between a point A101 (u,v) on the image coordinates and a point A102 (X_w,Y_w,Z_w) on the world coordinates.

$$S [ \begin{matrix}u \\ v \\ 1\end{matrix} ] = [ \begin{matrix}{C}_{11} & {C}_{12} & {C}_{13} & {C}_{14} \\ {C}_{21} & {C}_{22} & {C}_{23} & {C}_{24} \\ {C}_{31} & {C}_{32} & {C}_{33} & {C}_{34}\end{matrix} ] [ \begin{matrix}{X}_{w} \\ {Y}_{w} \\ {Z}_{w} \\ 1\end{matrix} ] \qquad [ Ex . 1 ]$$

Here, twelve parameters C_11 to C_14, C_21 to C_24 and C_31 to C_34 in (Ex. 1) are camera parameters, and are hereinafter generally called camera parameters C. Further, when the n-th index point is represented by image coordinates (u_n,v_n) and the world coordinates (X_n,Y_n,Z_n), [Ex. 2]is satisfied based on (Ex. 1).

C₁₁Xₙ+C₁₂Yₙ+C₁₂Zn+C₁₄−uₙ(C₃₁Xₙ°C₃₂Yₙ+C₃₃Zₙ+C₃₄)=0

C₂₁Xₙ+C₂₂Yₙ+C₂₃Zₙ+C₂₄−vₙ(C₃₁Xₙ+C₃₂Yₙ+C₃₃Zₙ+C₃₄)=0 (Ex. 2)

Furthermore, (Ex. 2) is obtained for the first to the n-th index points, and the results are changed to a matrix. Then, a determinant represented by (Ex. 3) is obtained.

$$2 n ↕ {[ \underbrace{\begin{matrix}{X}_{1} & {Y}_{1} & {Z}_{1} & 1 & 0 & 0 & 0 & 0 & - {X}_{1} {u}_{1} & - {Y}_{1} {u}_{1} & - {Z}_{1} {u}_{1} \\ 0 & 0 & 0 & 0 & {X}_{1} & {Y}_{1} & {Z}_{1} & 1 & - {X}_{1} {v}_{1} & - {Y}_{1} {v}_{1} & - {Z}_{1} {v}_{1} \\ & & & & & & ⋮ & & & & \\ {X}_{n} & {Y}_{n} & {Z}_{n} & 1 & 0 & 0 & 0 & 0 & - {X}_{n} {u}_{n} & - {Y}_{n} {u}_{n} & - {Z}_{n} {u}_{n} \\ 0 & 0 & 0 & 0 & {X}_{n} & {Y}_{n} & {Z}_{n} & 1 & - {X}_{n} {v}_{n} & - {Y}_{n} {v}_{n} & - {Z}_{n} {v}_{n}\end{matrix}}_{A} ]}^{{↔}^{11}} \\ [ \underbrace{\begin{matrix}{C}_{11} \\ {C}_{12} \\ ⋮ \\ {C}_{32} \\ {C}_{33}\end{matrix}}_{C} ] {↕}^{11} = [ \underbrace{\begin{matrix}{C}_{34} {u}_{1} \\ {C}_{34} {v}_{1} \\ ⋮ \\ {C}_{34} {u}_{n} \\ {C}_{34} {v}_{n}\end{matrix}}_{B} ] {↕}^{2 n} \qquad [ Ex . 3 ]$$

In addition, when a matrix expressed by 2n×11 in (Ex. 3) is denoted by a matrix A, a matrix expressed by eleven rows of C_11 to C_33 is denoted by a matrix C and the rest is denoted by a matrix B, (Ex. 5) can be obtained by converting the matrixes in accordance with (Ex. 4). It should be noted that A⁻¹ is regarded as an inverse matrix of the matrix A and A^{T} is regarded as a transposed matrix of the matrix A.

AC=B

A^{T}AC=A^{T}B

(A^{T}A)⁻¹(A^{T}A)C=(A^{T}A)⁻¹A^{T}B [Ex. 4]

C=(A^{T}A)⁻¹A^{T}B [Ex. 5]

That is, C_34=1, and the matrix A and the matrix B are determined based on the world coordinates and the image coordinates of n index points, wherein n is equal to or greater six and satisfies 2n>11. Thus, the matrix C is calculated by employing (Ex. 5), and the camera parameters C can be obtained.

When the camera parameters C are obtained, a transformation between the image coordinates and the world coordinates is enabled. For a transformation from the world coordinates to the image coordinates, a world coordinate value is input to (X_w,Y_w,Z_w) in (Ex. 1) to calculate the scale s, and thereafter the image coordinates (u,v) are obtained. That is, when the three components of the world coordinates are determined, the image coordinates can be uniquely determined.

For a transformation from the image coordinates to the world coordinates, the number of dimensions is insufficient because the image coordinates are two-dimensional while the world coordinates are three-dimensional, and one dimension of the world coordinates to be obtained is fixed for transformation. Normally, the scale s is calculated by employing Z_w, which represents the height in the world coordinates to be obtained by transformation, and the image coordinates. Then, X_w and Y_w are obtained by employing s, u and v. That is, when the image coordinates and one component of the world coordinates are determined, the remaining two components of the world coordinates can be uniquely determined.

A simple calibration accuracy evaluation can be performed by employing the transformation from the world coordinates to the image coordinates. For example, the camera parameters C are obtained based on the n-th index point, which is located at the image coordinates (u_n,v_n), and the world coordinates (X_n,Y_n,Z_n), and by employing the camera parameters C, the world coordinates can be transformed to obtain an image coordinate value (u_n,v_n) . Then, the average calibration error e_average for a index points is represented by (Ex. 6), using the value (u′_n,v′_n).

$${e}_{average} = \frac{1}{α} {\sum }_{j}^{α} ( \sqrt{{( {u}_{j} - {u}_{j}^{′} )}^{2} + {( {v}_{j} - {v}_{j}^{′} )}^{2}} ) \qquad [ Ex . 6 ]$$

In an open space for wide area surveillance, for example, when calibration for a plurality of cameras is performed for one world coordinate system, wherein an arbitrary point in real space is selected as the original point, the world coordinates for an index point are measured using triangulation, etc. When the color or shape of the index point is a characteristic, generally, image processing is performed to identify a corresponding point on the image coordinates.

### Non-patent Document 1: “A Versatile Camera Calibration Technique for High-Accuracy 3D Machine Vision Metrology Using Off-the-Shelf TV Cameras and Lenses”, R. Y Tsai, IEEE J. Robotics and Automation, Vol RA-3, NO. 4, pp. 323-331, Aug. 1987

### DISCLOSURE OF THE INVENTION

Problems that the Invention is to Solve

However, when the related method is employed to perform calibration outdoors, for example, the image recognition function does not operate correctly due to the background or light, etc., and in some cases, the world coordinates and the image coordinates have to be manually coordinated with each other. In a case wherein coordinates are manually correlated, since human input errors, such as world coordinate input errors, may occur when a plurality of index points are arranged irregularly, an incorrect world coordinate value may be entered for the world coordinates of a selected index point, and image coordinate input errors may occur, since an index point can not be distinguished from the peripheral background, and a location different from that for the original image coordinates may be designated.

According to the related method, a user repetitively performs the following operation. The user reads a numerical value for a calibration error to designate a portion wherein a human input error has occurred, or reads an image coordinate value to identify, in an image, an index point whereat an input error has occurred, and enters the correct world coordinates or correct image coordinates. Thus, a great deal of labor accompanies an operation for removing a calibration error that occurred as the result of a human input error.

The present invention is provided while taking the related shortcomings into account. One objective of the invention is to provide a camera calibration apparatus and a camera calibration method that can simplify a calibration correction operation.

### MEANS FOR SOLVING THE PROBLEMS

According to the present invention, a camera calibration apparatus, which obtains camera parameters based on a correlation between world coordinates, in real space, and image coordinates, in an image recorded by a camera, comprises calibration means for obtaining camera parameters by employing a set of coordinates for an index point, for which a coordinate value on the world coordinates is previously known, and a corresponding point on the image coordinates, which is correlated with the index point, detection means for detecting a correlation error for a correlation between the world coordinate value of the index point and an image coordinate value of the corresponding point, and display control means for displaying the detected correlation error on an image display device, by correlating the index point with the corresponding point.

According to this arrangement, since the display control means is provided that displays the detected correlation error on the image display device by correlating the index point with the corresponding point, the index point, for which calibration should be corrected, and the corresponding point can be easily identified. Therefore, the calibration correction operation can be simplified.

Further, for the camera calibration apparatus of the invention, the display control means displays the detected correlation error while providing visual effects. With this arrangement, since the display control means displays the detected correlation error by providing visual effects, the index point, for which calibration should be corrected, and the corresponding point can be easily identified. Thus, the calibration correction operation can be more simplified.

Furthermore, for the camera calibration apparatus of the invention, the display control means displays the detected correlation error by using a display form that is consonant with the results obtained by calculating a calibration error. According to this arrangement, since the display control means displays the detected correlation error by using a display form consonant with the results obtained by calculating a calibration error, whether a calibration error has been reduced by the calibration correction operation can be determined. Therefore, the calibration correction operation can be efficiently performed.

In addition, for the camera calibration apparatus of the invention, the display control means highlights a component of a world coordinate value in which the correlation error has been detected. According to this arrangement, since the display control means highlights the component of the world coordinate value in which the correlation error has been detected, the component of the world coordinate value to be corrected can be easily identified. Thus, the calibration correction operation can be further simplified.

Moreover, for the camera calibration apparatus of the invention, the display control means enlarges an area for displaying the detected correlation error. According to this arrangement, since the display control means enlarges the area wherein the detected correlation error is displayed, the index point, for which calibration should be corrected, and the corresponding point can be more easily identified. Therefore, the calibration correction operation can be further simplified.

Also, for the camera calibration apparatus of the invention, each time a correlation error is detected, the display control means sequentially displays the correlation error. According to this arrangement, each time a correlation error is detected, the display control means displays the correlation error. Therefore, while viewing an image that is output by a camera and displayed, calibration can be corrected in real time.

Further, for the camera calibration apparatus of the invention, the display control means displays the correlation error by employing currently obtained camera parameters, and based on two components of the world coordinates, which are calculated by using an arbitrary point designated on the image display device and the remaining component of the world coordinates that is input. According to this arrangement, the display control means displays the correlation error by employing currently obtained camera parameters, and based on two components in the world coordinates, which are calculated using an arbitrary point designated on the image display device and the remaining component in the world coordinates that is input. Thus, since the camera parameter error can be presented to apprehend through intuition, the calibration accuracy can be confirmed at the location whereat the camera parameters are obtained.

Furthermore, for the camera calibration apparatus of the invention, the display control means displays the correlation error based on a corresponding point on the image coordinates that is obtained by performing image recognition for the index point. According to this arrangement, the display control means displays the correlation error based on the corresponding point on the image coordinates that is obtained by performing image recognition for the index point, and coordinates of the corresponding point need not be entered manually. Thus, human input errors can be reduced.

In addition, for the camera calibration apparatus of the invention, the display control means displays the correlation error by using a display form consonant with the results obtained by calculating a calibration error. According to the arrangement, since the display control means displays the correlation error by using a display form consonant with the results obtained by calculating a calibration error, a user can easily determine whether an index point obtained through image recognition has been correctly entered.

Moreover, according to the invention, a camera calibration method for obtaining camera parameters based on a correlation of world coordinates, located in real space, and image coordinates, located on an image recorded by a camera, comprises the steps of obtaining camera parameters by employing a set of coordinates for an index point, for which a world coordinate value is well known, and a corresponding point on the image coordinates, which is correlated with the index point, detecting a correlation error for a correlation between the world coordinate value of the index point and an image coordinate value of the corresponding point, and displaying the detected correlation error on an image display device by correlating the index point with the corresponding point.

### ADVANTAGE OF THE INVENTION

According to the present invention, since a detected correlation error is displayed on an image display device by correlating an index point with a corresponding point that are correlated with each other, the index point, for which calibration should be corrected, and the corresponding point can be easily identified. Therefore, the calibration correction operation can be simplified.

### BRIEF DESCRIPTION OF THE DRAWINGS

FIG. 1 A schematic configuration diagram for explaining a calibration apparatus according to one mode of the present invention.

FIG. 2 A flowchart for explaining the calibration processing performed for the mode of the invention.

FIG. 3 A flowchart for explaining the camera parameter preparation processing according to the mode of the invention.

FIG. 4 A diagram showing an example display screen during the calibration correction operation in the mode of the invention.

FIG. 5 A diagram showing an example display screen during the calibration correction operation in the mode of the invention.

FIG. 6 A diagram showing an example display screen during the calibration correction operation in the mode of the invention.

FIG. 7 A diagram showing an example display screen during the calibration correction operation in the mode of the invention.

FIG. 8 A diagram showing an example display screen during the calibration correction operation in the mode of the invention.

FIG. 9 A diagram showing an example display screen during the calibration correction operation in the mode of the invention.

FIG. 10 A diagram showing a correlation between image coordinates and world coordinates used for calibration.

### DESCRIPTION OF THE REFERENCE NUMERALS AND SIGNS

A101 camera
A111 calibration apparatus
A112 display controller
A113 calibration unit
A114 calibration correction unit
A121 monitor
A131 input device
A402 camera parameter preparation results window
A403 index point management number
A404 index icon
A405 calibration error display frame
A406 correction window
A501 camera parameter preparation results table
A502 calibration error display frame

### BEST MODE FOR CARRYING OUT THE INVENTION

The mode of the present invention will now be described while referring to the drawings. It should be noted, however, that the present invention is not limited to this mode, and can be carried out by using various modes, without departing from the subject of the invention.

The present invention relates to a camera calibration apparatus and a camera calibration method for obtaining camera parameters based on a correlation between world coordinates located in real space and image coordinates located on an image recorded by a camera. In this mode, an explanation will be given for a case wherein a plurality of index points, for which the world coordinates were previously known, are prepared, and corresponding points on the image coordinates are manually obtained to acquire camera parameters.

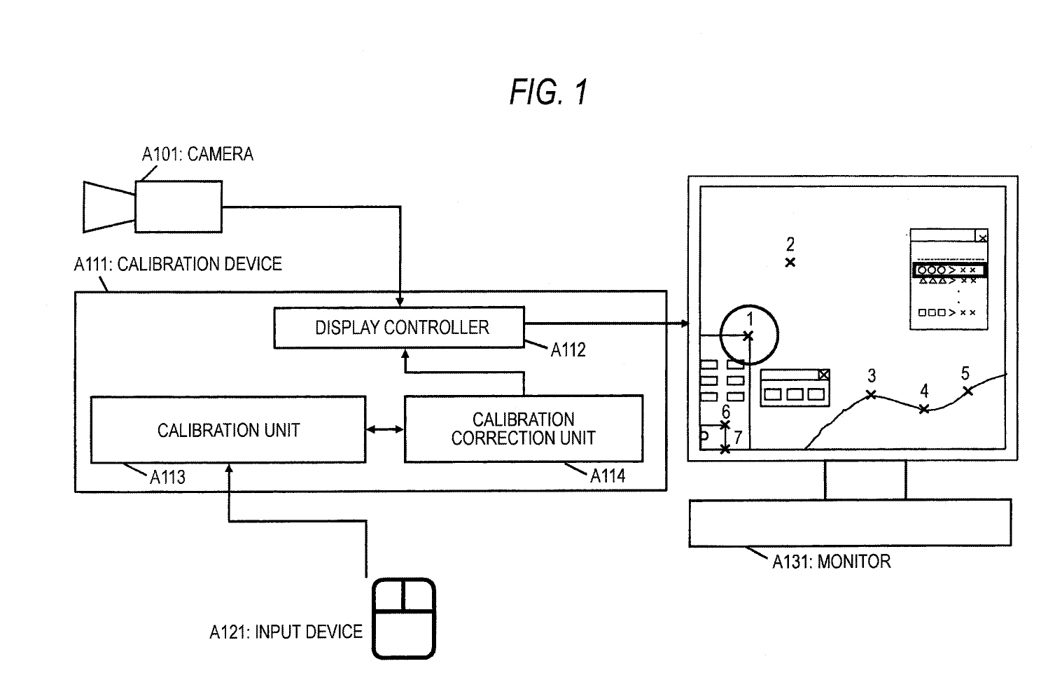

FIG. 1 is a schematic configuration diagram for explaining a calibration apparatus of one mode of the present invention. In FIG. 1, a camera A101 outputs a recorded image to a calibration apparatus A111. The calibration apparatus A111 obtains camera parameters based on a correlation between world coordinates and image coordinates. An input device A121 employs a mouse or a keyboard, for example, to enter information for the calibration apparatus A111. A monitor A131 displays an image output by the calibration apparatus A111.

The calibration apparatus A111 includes: a display controller A112, for synthesizing image information and calibration results; a calibration unit A113, for obtaining camera parameters by employing a set of coordinates for an index point, for which a world coordinate value was previously known, and for a point on the image coordinates that corresponds to the index point; and a calibration correction unit A114, which calculates a calibration error, detects a correlation error between the world coordinate value of the index value and the image coordinate value, and performs a correction process.

The camera A101 employs, as input, an image taken using the lens, and outputs video image data to the display controller A112. The display controller A112 employs, as input, image data output by the camera A101 and the calibration results output by the calibration correction unit A114, and outputs, to the monitor A131, image data obtained by superimposing video information on the calibration error results. That is, the display controller A112 displays on the monitor A131 a correlation error detected by the calibration correction unit A114 by correlating an index point with the corresponding point.

The calibration unit A113 employs, as input, numerical values entered at the keyboard and through the manipulation of the mouse, which are output by the input device A121, prepares sets of index point coordinates, which represent correlations of management numbers for the index points with the world coordinates and the image coordinates, and outputs camera parameters, the world coordinates and image coordinates to the calibration correction unit A114. Further, the calibration unit A113 employs, as input, a set of index point coordinates output by the calibration correction unit A114 and outputs camera parameters to the calibration correction unit A114.

The calibration correction unit A114 employs, as input, the camera parameters and the set of index point coordinates that are output by the calibration unit A113, and outputs the calibration results to the display controller A112. Further, during the calculation of the calibration results, the calibration correction unit A114 outputs the set of index point coordinates to the calibration unit A113. The input device A121 depends, for input, on manipulation by a user, and outputs, to the calibration unit A113, numerical values entered at the keyboard and manipulation of the mouse.

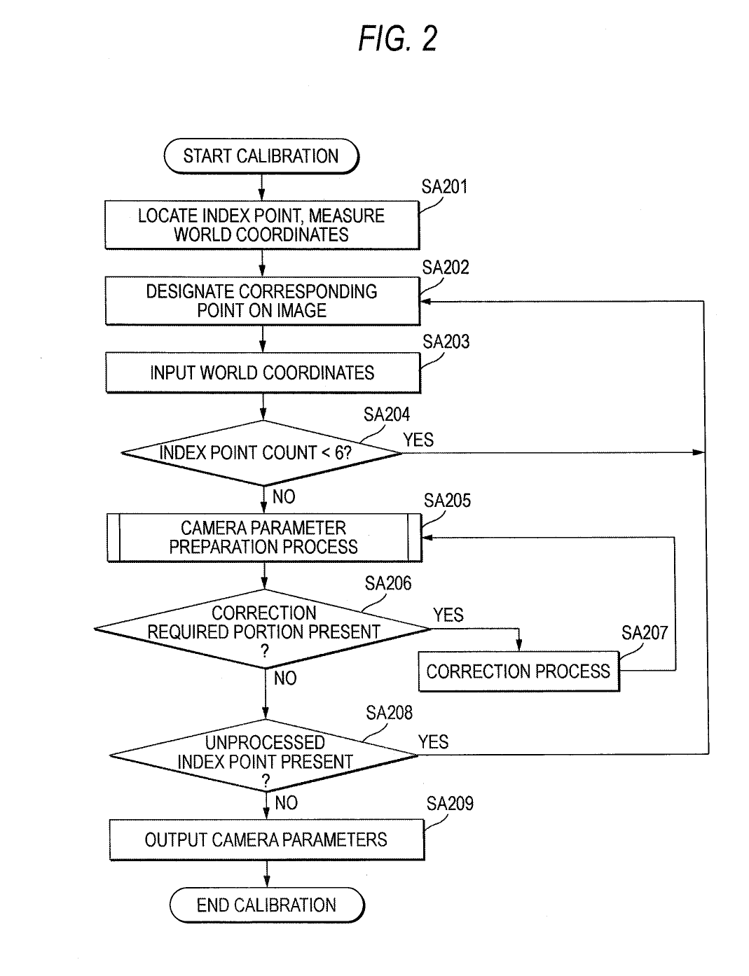

FIG. 2 is a flowchart for explaining the calibration processing. A calibration method will now be explained while referring to FIG. 2. In FIG. 2, when calibration is started, at step SA201, a user positions an index point in the recording range of the camera A101 and measures, in advance, the world coordinates of the index point using triangulation, etc.

At step SA202, the user searches for the index point on the screen of the monitor A131 whereon the index point was positioned at step SA201, and clicks on the index point after positioning the mouse pointer in the center of the index point. In this manner, the image coordinates for the index point are designated.

At step SA203, since the window for entering world coordinates is automatically displayed on the screen of the monitor A131, the user employs the keyboard to enter the coordinate values for the world coordinates measured in advance.

At step SA204, the calibration unit A113 prepares a set of index point coordinates based on the world coordinates and the image coordinates that have been entered. Then, a check is performed to determine whether a condition (the number of sets of index point coordinates<6) has been satisfied. When this condition has been satisfied (Yes) , camera parameters can not be created, and program control returns to step SA202. For other cases (No), program control advances to step SA205.

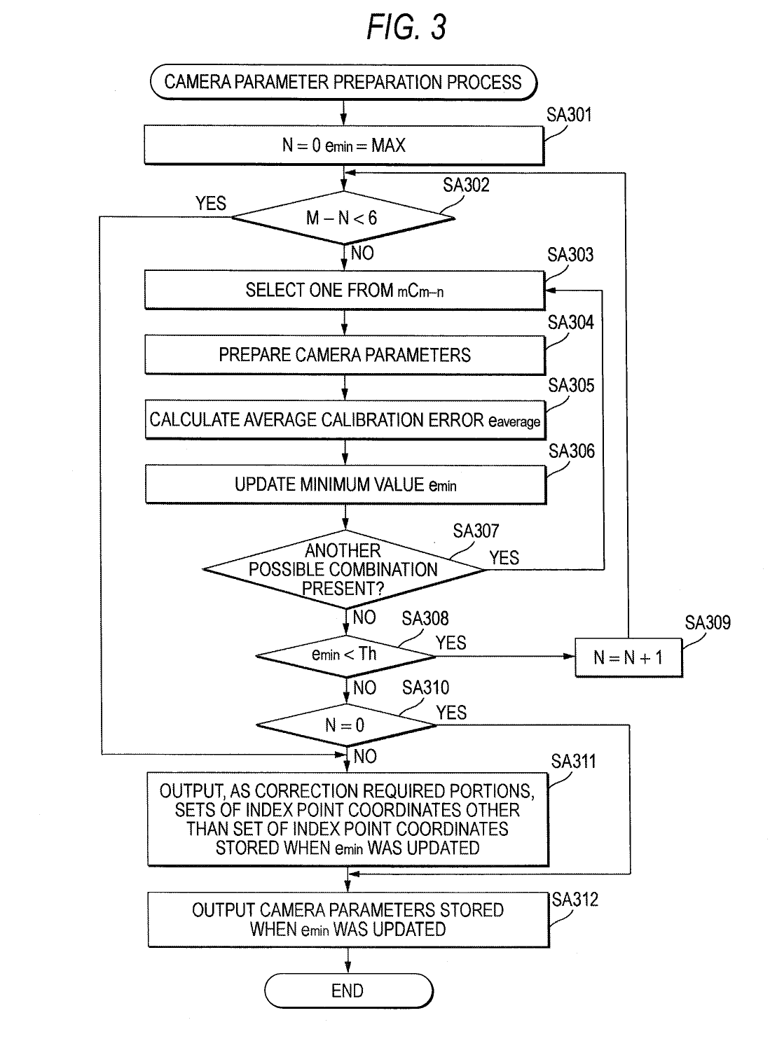

At step SA205, the calibration unit A113 and the calibration correction unit A114 perform the camera parameter preparation process. Then, an error in the correlation, between the world coordinate value of the detected index point and the image coordinate value of the corresponding point, is displayed, with the correlation of the index point and the corresponding point. The camera parameter preparation process will be described in detail while referring to the flowchart in FIG. 3.

At step SA206, the results obtained during the process at SA205 are examined. When a calibration error is present in the process results (Yes), program control advances to step SA207, or in the other case (No) , program control goes to step SA208. At step SA207, the user performs the error correction process for the calibration error. After the correction process has ended, program control returns to step SA205.

At step SA208, the calibration unit A113 determines whether the number A of sets of index point coordinates, which is required to maintain a predetermined calibration accuracy, is greater than the number B of sets of index point coordinates that were employed for preparation of the camera parameters that were output at step SA205. When B<A (Yes), program control returns to step SA202. When A<=B (No), to obtain the number of coordinates of index points that are required for the calculation of camera parameters, program control advances to step SA209. At step SA209, the camera parameters are output and calibration is terminated.

FIG. 3 is a flowchart showing the camera parameter preparation process at step SA205 in FIG. 2. When the camera parameter preparation process is started, at step SA301 0 is employed for a loop variable N that represents the number of incorrect sets of index point coordinates, and a probable maximum value or greater is substituted into a minimum value e_min for the average calibration error.

At step SA302, the calibration correction unit A114 determines whether the number (M-N) of sets of index point coordinates used for the preparation of camera parameters is smaller than six, where M is the number of sets of index point coordinates provided for the camera parameter preparation process. When M-N is smaller than six (Yes), program control is shifted to step SA311, or when M-N is equal to or greater than six (No), program control advances to step SA303.

At step SA303, (M-N) sets of index point coordinates are selected from M sets. Then, at step SA304, the calibration correction unit A114 outputs to the calibration unit A113 a group of the sets of index point coordinates that are selected at step SA303, and receives camera parameters from the calibration unit A113.

At step SA305, the calibration correction unit A114 calculates an average calibration error e_average. Following this, at step SA306, e_min is compared with e_average. When e_average is the minimum value, this value is updated, and the current (M-N) sets of index point coordinates and the camera parameters are stored.

At step SA307, a check is performed to determine whether there is another combination present for selecting (M-N) sets of index point coordinates from M sets, which has been performed at step SA303. When there is another combination present (Yes) , program control returns to step SA303. When all the possible combinations have been performed (No) program control advances to step SA308.

At step SA308, e_min is compared with a threshold value Th for the average calibration error. When e_min>Th (Yes), program control is shifted to step SA309, or in other cases, program control advances to step SA310. The calibration error threshold value Th can be arbitrarily changed by a user, and may be changed in accordance with the results of the camera parameter preparation process.

At step SA309, since the average calibration error is greater than the threshold value, it is assumed that an incorrect set of index point coordinates is present, and the loop variable N, representing the number of incorrect sets of index point coordinates, is incremented by one, and program control returns to step SA302.

At step SA310, a check is performed to determine whether N=0. When N=0 (Yes) , no calibration error has been found, and program control goes to step SA312. In the other cases (No) , an error is present, and program control advances to step SA311.

At step SA311, a group of sets of index point coordinates, other than those stored when e_min was updated at step SA306, is output as a calibration error. This is an algorithm based on the following idea. For the group of sets of index point coordinates that are stored when e_min was updated at step SA306, a predetermined accuracy such that the average calibration error is equal to or lower than Th is maintained. Therefore, the other sets of index point coordinates include a calibration error, such as a world coordinate input error.

At step SA312, the camera parameters and the (M-N) sets of index point coordinates, which were stored when e_min was updated at step SA306, are output, and the camera parameter preparation process is ended.

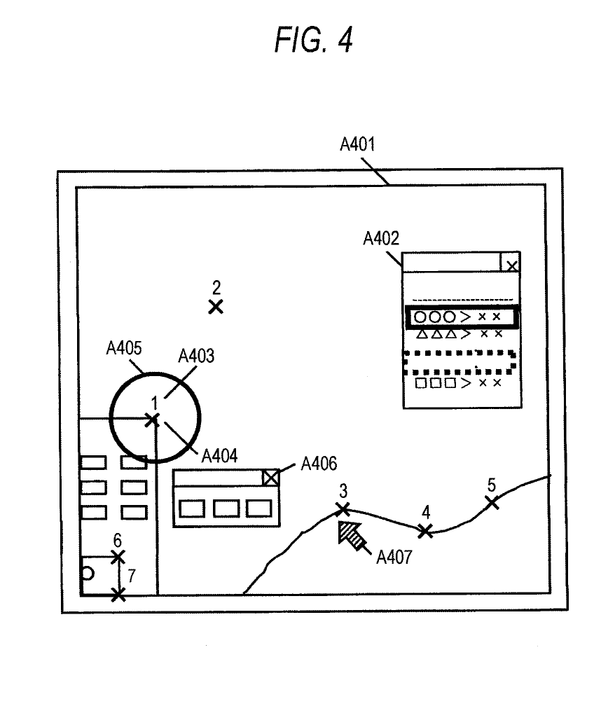

FIGS. 4 to 9 are diagrams showing the screen during a correction process. The correction process will be described while referring to FIGS. 4 to 9. The screen during the correction process is shown in FIG. 4. A401 denotes the video image of the camera A101; A402 denotes a camera parameter preparation process results window; A403 denotes an index point management number; A404 denotes an index icon that represents the location of an index point on the screen; A405 denotes an error display frame indicating a set of index point coordinates, for which it is speculated that a calibration error has occurred; A406 denotes a correction window; and A407 denotes a mouse pointer.

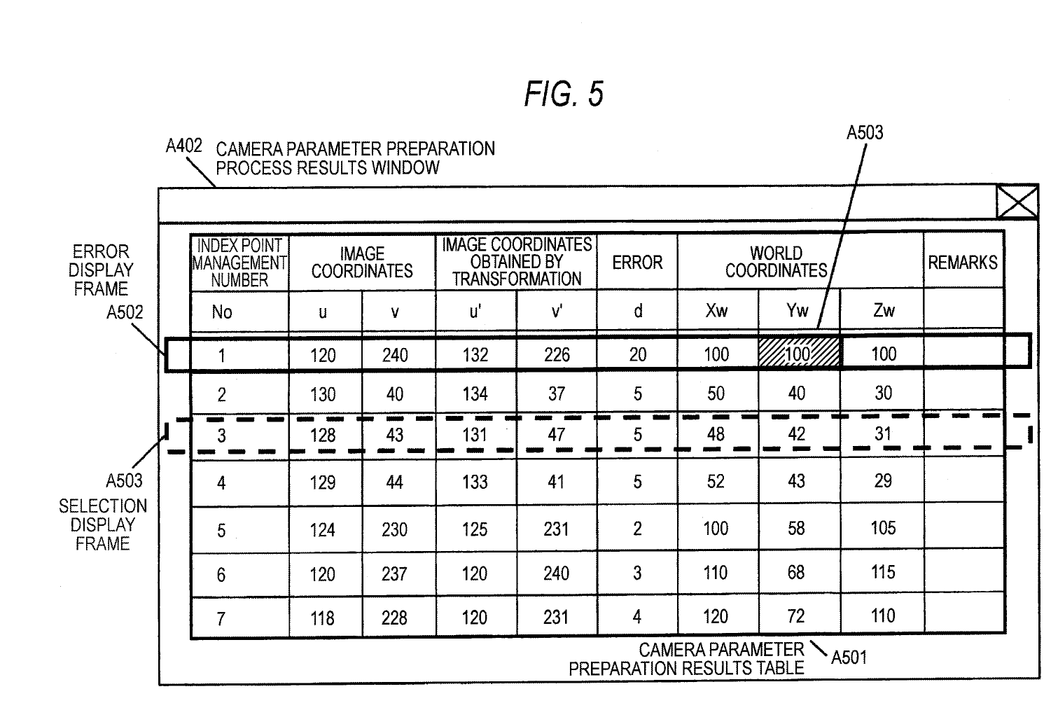

FIG. 5 is a diagram showing the camera parameter preparation process results window A402. A camera parameter preparation results table A501 is shown, and an error display frame A502 indicates a set of index point coordinates, for which it is speculated that a calibration error has occurred. A selection display frame A503 indicates a set of index point coordinates that is pointed at by the mouse pointer.

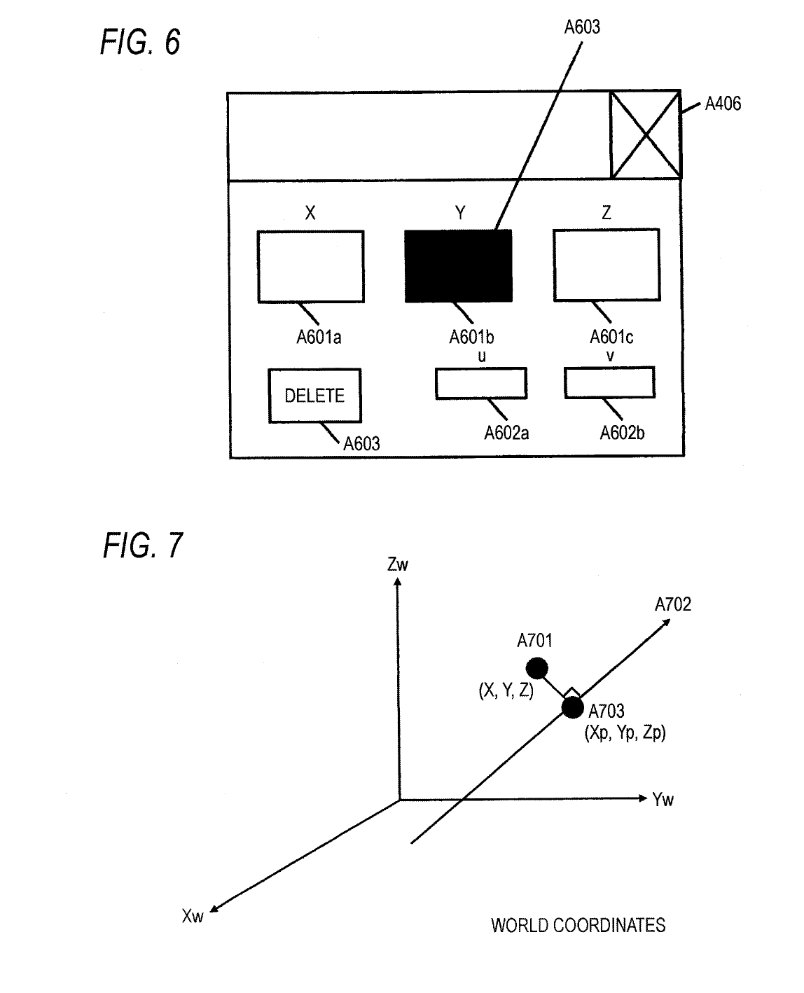

FIG. 6 is a diagram showing the correction window A406, and world coordinate correction forms A601a, A601b and A601c, image coordinate correction forms A602a and A602b and a delete button A603 are shown.

When calibration is initiated, the video screen A401 (see FIG. 4) recorded by the camera A101 is displayed on the screen of the monitor A131. When a set of index point coordinates is thereafter entered, the index point management number A403 and the index point icon A404 are displayed at corresponding locations on the screen. When the user watches the index point A403 and the index point A404, the user can easily identify the location (image coordinates) on the screen of the set of index point coordinates that has been entered.

When several sets of index point coordinates have been entered and the camera parameter preparation process SA205 has been completed, the camera parameter preparation results window A402 (see FIG. 5) is displayed. In the camera parameter preparation results window A402, the camera parameter preparation results table A501 is displayed that includes individual components, such as index point management numbers, image coordinates, image coordinates obtained by transformations that employ world coordinates and camera parameters, calibration errors that are errors between image coordinates and the image coordinates obtained by transformation, world coordinates and remarks. Thus, the contents of the individual sets of index point coordinates and the calibration errors can be examined. At this time, correlation of the world coordinates with image coordinates, correlation of the calibration error, etc., are performed, for the index point icon that is displayed on the screen and the index point icon that is displayed in the camera parameter process results window A402, while visual effects are provided.

It should be noted that data for all the sets of index point coordinates need not especially be displayed in the camera parameter preparation results table A501, which is displayed in the camera preparation results window A402. For example, in order to clearly identify a set of index point coordinates to be corrected, information may be displayed as it is for a set of index point coordinates for which a calibration error (a correlation error) is present (a row pertinent to index point management number “1”) and the set of index point coordinates for the index point icon that is pointed to using the mouse pointer A407. Or, information displayed may not be limited to this.

Reason for displaying other information is the assumption a case exists wherein correction is performed while data is observed for other index points. For example, assume that the index points are arranged at the same intervals on the screen, and that, although the heights of the individual index points are constant on the world coordinates, the heights actually entered on the world coordinates are different. In this case, correct values can be easily entered by referring to the world coordinates of another set of index points coordinates.

When a calibration error is present, the error display frame A405 is displayed while the index icon (index point management number 1) of the incorrect index point is located in the center, and the error display frame A502 is displayed in the row (index point management row number 1) in the camera parameter preparation results window A402 that corresponds to the incorrect index point. When a user views the calibration error display frame A405, the user can easily identify which set of index point coordinates on the screen is incorrect. As described above, by employing the error display frames A405 and A502, a correlation error can be displayed by correlating the index point with the corresponding point. Therefore, the index point, for which correction of calibration should be performed, and the corresponding point can be easily identified. Thus, the calibration correction operation can be simplified.

For the error display frame A405 and the error display frame A502, the types, the colors, the thicknesses and the shapes thereof are standardized, so that correlation of the world coordinates with the image coordinates, correlation of the calibration error, etc., can be precisely performed between the index point icon displayed on the screen and the index point icon displayed in the camera parameter process results window A402. Therefore, an index point for which calibration should be corrected and the corresponding point can be easily identified, and the calibration correction operation can be further simplified.

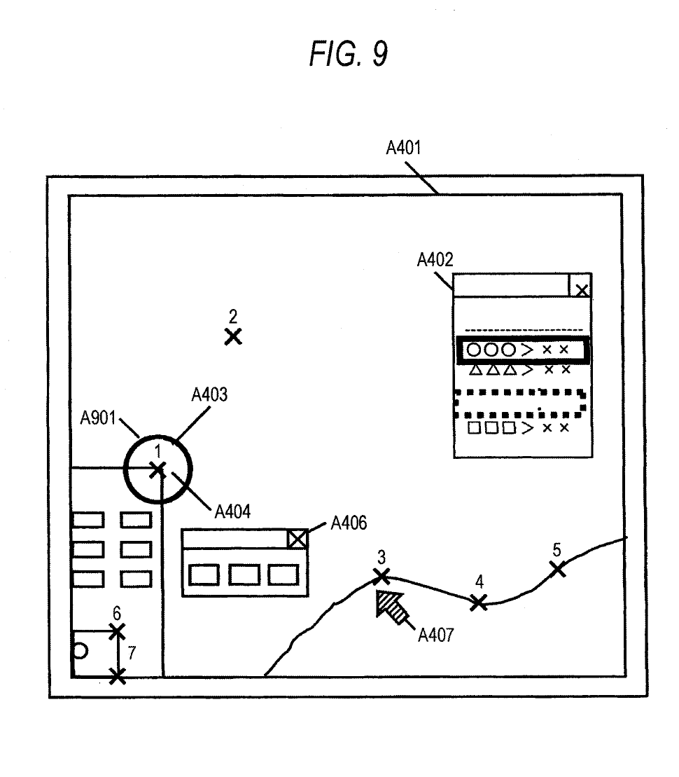

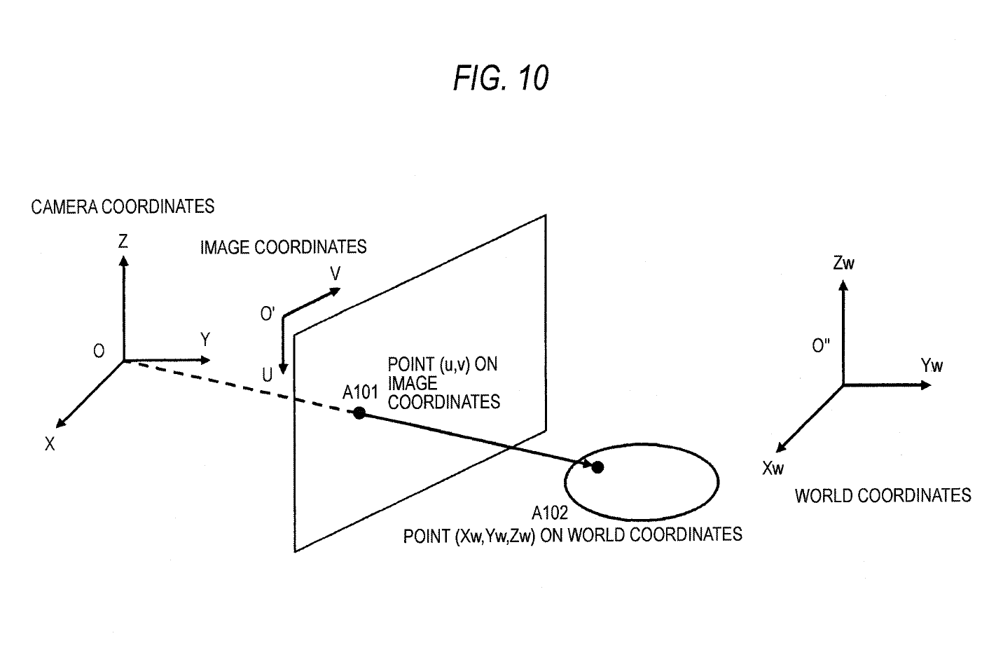

Further, for the calibration error display frames A405 and A502, the types, the colors, the shapes, etc., are determined in accordance with the calibration error. For example, assume that the world coordinates and the image coordinates for the set of index point coordinates indicated in the error display frame A502 in FIG. 5 are corrected, and that the calibration error is reduced from 20 to 10. In this case, since the error is reduced by half, the radius of the circle for the error display frame A405 on the screen in FIG. 4 is also reduced by half, and an error display frame A901 shown in FIG. 9 is obtained. Further, when the calibration error is correctly corrected and falls within a permissible range, the error display frame disappears.

As a result, based on the radius of the circle for the error display frame on the screen, the relative size of the calibration error can be identified, and can be employed to determine the priority order for the correction operation. Also, the change in the calibration error is reflected by the change in the diameter of the error display frame, which is visually displayed. Thus, a change displayed in this manner can more intuitively be apprehended than can watching a change expressed using numerical values.

There are two types of methods used to perform the correction process by employing error display frames. There are a case wherein the world coordinates and the image coordinates in the camera parameter preparation process window A402 are designated by using the mouse pointer A407, and are corrected directly by the entry of numerical values using a keyboard, for example, and a case wherein the mouse pointer A407 is moved near an icon on the screen for an index point that is to be corrected, and the index point icon is selected by an operation, such as double clicking, and wherein the correction window A406 is displayed to correct the thus selected index point.

When image coordinates are to be corrected by using the correction window A406, either the index point icon A404 is dragged by using the mouse pointer A407 and is moved to a correct position on the screen, or a corrected value is entered in the image coordinate correction form A602 in the correction window A406. When the world coordinates are to be corrected, a corrected value is entered in the world coordinate correction form A601 in the correction window A406.

In this mode, an incorrect world coordinate component or an image coordinate component included in a set of index point coordinates to be corrected is presented in order to improve the efficiency of the correction operation. When the image coordinates are incorrect, a user finds the incorrect component by determining whether an index point icon is present at the position of the index point that was located during calibration.

When world coordinates are incorrect, the incorrect portion is presented by inverting the color of the incorrect portion, like the selection display frame A503 in FIG. 5 or A603 in FIG. 6.

As a method for estimating how incorrect is a world coordinate component, when, for example, the camera parameters C and image coordinates (u,v) and world coordinates A701 (X,Y,Z), in the world coordinates shown in FIG. 7, for a set of index point coordinates are employed, a linear line A702 can be drawn through the world coordinates by employing as parameters the camera parameters C, image coordinates (u,v) and the scale s. This linear line is a line that represents the location on the world coordinates at which image coordinates (u,v) are transformed by using the camera parameters C.

When the world coordinates A701 for the index point coordinate set are correct, the index point is present on the linear line A702. When the world coordinates A701 are incorrect, the index point is separated from the linear line. By employing this principle, a point A703 (Xp,Yp,Zp), on the linear line A702, that is nearest the world coordinates A701 is obtained, and a check is performed to determine whether differences |X-Xp|, |Y-Yp| and |Z-Zp|, between the individual components of the point A703 and the world coordinates A701, are equal to or greater than a threshold value. Then, it can be estimated that a world coordinate component that is equal to or greater than the threshold value is incorrect.

Further, by employing the estimation results, the component (e.g., Xp when it is estimated that the X component in the world coordinates is incorrect) of the point A703 (Xp, Yp, Zp) maybe substituted into the corresponding component on the world coordinates that it has been estimated is incorrect, so that an automatic correction can also be performed.

Furthermore, a table consisting of a world coordinates list, which represents the world coordinates for all the measured index points, may be stored in order to provide a world coordinate value that can be chosen, during the correction process, on the assumption that the world coordinates and the image coordinates for a set of index point coordinates are correct, but that when this set was entered, the correlation of the world coordinates with the image coordinates was incorrect.

When, for example, the image coordinates (u,v) of a set of index point coordinates to be corrected, the N-th world coordinates (X_N,Y_N,Z_N) in the world coordinates list and the image coordinates (u_N,v_N), which are obtained by transformation performed using the world coordinates (X_N,Y_N, Z_N) andthecameraparameters, are employed, world coordinates (X_N,Y_N,Z_N) are the chosen world coordinate values when the difference in the distance between image coordinates (u,v) and image coordinates (u_N,v_N) is the smallest.

In addition, to enter or to correct the image coordinates using a mouse, etc., the video screen around the periphery of the mouse pointer may be temporarily enlarged and displayed. This provides an effect for the reduction of errors that would occur during the manual entry or correction of image coordinates.

Further, assuming that the image coordinates manually entered are shifted slightly because manipulation of the mouse is an unfamiliar activity, camera parameter calculation may be performed by providing a specific range for the image coordinates for a set of index point coordinates that was employed when the camera parameters were prepared. And camera parameters, when the average calibration error is the minimum, may be automatically obtained.

Moreover, one world coordinate component may be provided in advance, and by clicking on it, using the mouse, an arbitrary point may be designated on the screen whereat the camera parameters have been obtained. Then, the two remaining components of the world coordinates may be calculated based on the currently obtained camera parameters, and the calculation results may be presented to the user, so that the calibration accuracy can be confirmed. In this manner, an error in the camera parameters can be presented so that it can be intuitively apprehended.

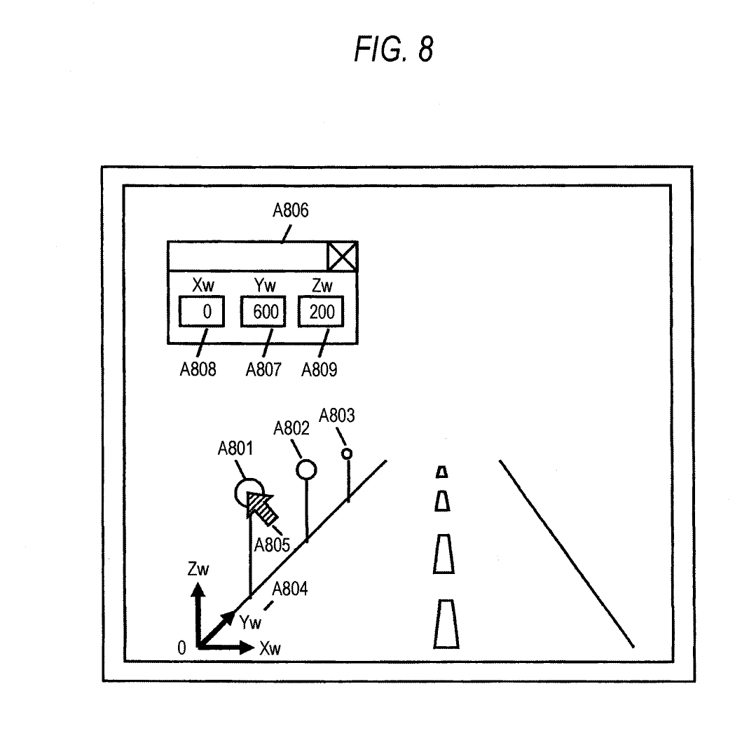

When, for example, traffic signs A801 to A803, 2 m tall, are arranged at intervals of 6 m in Y axial direction A804, as shown in FIG. 8, the Z component of the world coordinates is designated as 2 m. Then, a mouse pointer A805 is moved to the individual vertexes of the traffic signs, which are sequentially clicked on. When only a Y axial component A807 in a world coordinate display window A806 is changed every 6 m, and an X axial component A808 and a Z axial component A809 are not changed, it can be determined that a correct calibration has been performed.

As a result, at the location whereat the calibration has been performed, the calibration accuracy can be confirmed easily and intuitively. It should be noted that one component in the world coordinates may be corrected after being clicked on using the mouse, or the method may not be limited to this.

Further, each time a correlation error is detected for an index point and a corresponding point, the correlation error is displayed. As a result, a calibration can be corrected in real time while viewing, on a display, an image that is output by a camera.

Also in this mode, the image coordinates and the world coordinates of the index point are manually entered. However, in accordance with the color and the shape of the index point, the peripheral background, etc., a corresponding point on the image coordinates may be automatically obtained by using an image recognition technique, such as template matching. According to this arrangement, since the coordinates of a corresponding point need not be manually entered, human input errors can be reduced. At this time, a display method and a display form for an index point to be displayed should be changed in accordance with the value of the camera calibration error. The following examples are given: an obviously correct one is not to be displayed; when an error is large, the detection results or the templates employed are to be displayed; and normally, only the detection results are to be displayed. Since the display form for the index point is changed in accordance with the value of the calibration error, a user can easily determine whether the index point has been correctly entered using image recognition.

In this case, a correlation error for the image coordinates of a set of index point coordinates has occurred. Thus, in the calibration correction process, the results obtained by identifying the index point using image recognition, the image recognition condition, such as a threshold value, the index point template employed, etc., may be presented on the screen, so that a user can easily determine whether automatic recognition of the index point, through image processing, is correct. The method is not limited to this. In this manner, the process for entering image coordinates for a set of index point coordinates can be automated.

Moreover, when the world coordinates are correlated with the color and shape of the index point, the peripheral background, etc., entry of the world coordinates can also be automated, and calibration is enabled simply by recording an index point using the camera.

In addition, as a method for determining a calibration error, based on camera parameters that have been employed to calculate the world coordinates for a set of index point coordinates that was input, image coordinates may be obtained by transformation, and maybe displayed using different means from that used for an index icon. At this time, when a calibration error is small, the image coordinate point is near the position (the image coordinates for the input index point) of the index point icon. When a calibration error is large, the point is at a distance.

The calibration apparatus of this mode is useful when calibration is performed, for example, for security cameras located in shopping malls or in stations, along streets, etc. Further, the calibration apparatus can also be applied for calibration performed for a wide area surveillance cameras for monitoring airports, harbors and rivers.

The present invention has been explained in detail by referring to the specific mode. However, it will be obvious to one having ordinary skill in the art that various alterations and modifications can be added without departing from the spirit and scope of the present invention.

The present invention is based on a Japanese Patent Application (Japanese Patent Application No. 2004-247931) filed on Aug. 27, 2004, and the contents thereof are included as a reference.

### INDUSTRIAL APPLICABILITY

According to the present invention, since the display control means is included that displays a detected correlation error, on an image display device, by correlating the index point with a corresponding point, the index point, for which calibration correction is required, and the corresponding point can be easily identified. Therefore, the effect provided by the present invention is that the calibration correction operation is simplified. Thus, the present invention is useful for a camera calibration apparatus, a camera calibration method, etc., for obtaining camera parameters based on a correlation between world coordinates located in real space and image coordinates located on an image recorded by a camera.

1. A camera calibration apparatus, which obtains camera parameters based on a correlation between world coordinates in real space and image coordinates in an image recorded by a camera, comprising:
a calibration unit which obtains camera parameters by employing a set of coordinates for an index point, for which a coordinate value on the world coordinates is previously known, and a corresponding point on the image coordinates, which is correlated with the index point;
a detection unit which detects a correlation error for a correlation between the world coordinate value of the index point and an image coordinate value of the corresponding point; and
a display control unit which displays the detected correlation error on an image display device by correlating the index point with the corresponding point.

2. The camera calibration apparatus according to claim 1, wherein the display control unit displays the detected correlation error while providing visual effects.

3. The camera calibration apparatus according to claim 1, wherein the display control unit displays the detected correlation error by using a display form that is consonant with the results obtained by calculating a calibration error.

4. The camera calibration apparatus according to claim 1, wherein the display control unit highlights a component of a world coordinate value in which the correlation error has been detected.

5. The camera calibration apparatus according to claim 1, wherein the display control unit enlarges an area for displaying the detected correlation error.

6. The camera calibration apparatus according to claim 1, wherein, each time a correlation error is detected, the display control unit sequentially displays the correlation error.

7. The camera calibration apparatus according to claim 1, wherein the display control unit displays the correlation error by employing currently obtained camera parameters, and based on two components of the world coordinates, which are calculated by using an arbitrary point designated on the image display device and the remaining component of the world coordinates that is input.

8. The camera calibration apparatus according to claim 1, wherein the display control unit displays the correlation error based on a corresponding point on the image coordinates that is obtained by performing image recognition for the index point.

9. The camera calibration apparatus according to claim 8, wherein the display control unit displays the correlation error by using a display form consonant with the results obtained by calculating a calibration error.

10. A camera calibration method for obtaining camera parameters based on a correlation of world coordinates, located in real space, and image coordinates, located on an image recorded by a camera, comprising the steps of:
obtaining camera parameters by employing a set of coordinates for an index point, for which a world coordinate value is well known, and a corresponding point on the image coordinates, which is correlated with the index point;
detecting a correlation error for a correlation between the world coordinate value of the index point and an image coordinate value of the corresponding point; and
displaying the detected correlation error on an image display device by correlating the index point with the corresponding point.
